(19) United States
(12) Patent Application Publication
(10) Pub. No.: US 2005/0129382 A1
(43) Pub. Date: Jun. 16, 2005

(54) Signal light noise reduciton apparatus and signal light noise reduction method

(76) Inventors: Youichi Sakakibara, Ibaraki (JP); Madoka Tokumoto, Ibaraki (JP); Yohji Achiba, Tokyo (JP); Hiromichi Kataura, Tokyo (JP); Mark Kenneth Jablonski, Tokyo (JP); Yuichi Tanaka, Tokyo (JP)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/505,425

(22) PCT Filed: Feb. 19, 2003
(86) PCT No.: PCT/JP03/01755

(30) Foreign Application Priority Data
Feb. 25, 2002 (JP) 2002-048392

(51) Int. Cl. G02B 6/00

(52) U.S. Cl. 385/147

(57) ABSTRACT

An increase in the span of the transmission distance is aimed at by reducing unwanted ASE generated during optical communication. A carbon nanotube is employed as a saturable absorber 15 and this saturable absorber constitutes a noise reduction apparatus that has the function of cutting off or reducing transmission of unwanted ASE or the like which is of weak signal light intensity and of allowing transmission of signal light of strong light intensity. This noise reduction apparatus is arranged for example in the transmission path of signal light of a bidirectional excitation type EDFA, more precisely the apparatus is inserted in the latter stage of the EDF 40. In this way, carbon nanotubes having a saturable absorption function can be utilized in the field of optical communication.

### TECHNICAL FIELD

The present invention relates to apparatus for reducing noise of signal light in optical communication (hereinbelow referred to as noise reduction apparatus).

### BACKGROUND ART

With the enormous progress in optical communication technology in recent years, further increase in the span (increase in distance) of the transmission distance of signal light is desired.

A method that is currently adopted with a view to increasing the span of the transmission distance consists in compensating for the attenuation of signal light intensity that accompanies transmission distance by relaying the signal light through a transmission medium such as an optical fiber by a plurality of optical amplifiers that perform optical amplification of the signal light.

Optical fiber amplifiers that have attracted attention in recent years include erbium-doped fiber amplifiers (hereinbelow referred to as EDFAs) that make use of the phenomenon of stimulated emission using erbium exciting light.

Because of excellent matching with the transmission medium, optical fiber amplifiers are suitable for employment in optical transmission systems; EDFAs are particularly suitable since high gain and high efficiency can be achieved, due to matching of the amplification wavelength zone with the very low loss wavelength band of a quartz fiber in the 1500 nm wavelength band.

However, in the case of optical amplifiers such as, in particular EDFAs, amplified signal light is generated by a population inversion produced by the exciting ions. In the amplification step of this signal light, spontaneous emission that is randomly generated is also amplified, so amplified spontaneous emission (hereinbelow referred to as ASE) i.e. optical noise (also referred to as noise) is generated from the optical amplifier.

Since ASE having a random phase is added to the amplified signal light, the result is that the ratio of signal light to optical noise (S/N ratio) is severely affected.

Due to the admixture of ASE, not only is it not possible to output only prescribed signal light with high accuracy from the optical amplifier, but also the ASE undergoes repeated optical amplification during propagation through the optical fiber and other members in the same way as the signal light.

As a result, this undesired ASE that is generated presents a considerable obstacle to increasing the span of the transmission distance.

### DISCLOSURE OF THE INVENTION

Discovery of technical means for solving the above problems was therefore desired.

With this in view, first of all, the inventors of the present application conducted meticulous research focusing on the fact that, normally, the light intensity of the optical noise when initially generated is fairly small in comparison with the light intensity of the signal light. As a result, they discovered that it was possible to amplify exclusively the signal light and to suppress amplification of optical noise, by utilizing the characteristic possessed by a carbon nanotube saturable absorber, namely, that its absorption decreases with the square of the optical power, resulting in an abrupt increase in transmissivity, and that it was therefore possible to allow the propagation only of signal light and to cut off optical noise.

Accordingly, noise reduction apparatus of signal light according to the present invention has the following structural characteristics.

Specifically, this noise reduction apparatus is constructed using a carbon nanotube as the saturable absorber. This noise reduction apparatus may be arranged in the transmission path of the signal light in order to reduce signal light noise in optical communication.

With such a construction, the carbon nanotube constituting the saturable absorber cuts off transmission of for example ASE of weak light intensity and, in addition, transmits a signal of strong light intensity and so is capable of reducing signal light noise.

Preferably, also, the carbon nanotube may have optical non-linearity.

Preferably, also, by combination with an optical amplifier, the saturable absorber has a function as an optical isolator in respect of light propagated in the opposite direction to the signal light.

Light propagated in the opposite direction to the signal light may be for example reflected light of the signal light. The light intensity of the reflected light is weaker than the light intensity of the signal light. Consequently, furthermore, the saturable absorber can be made to function as an optical isolator of the signal light and the reflected light, making it possible to achieve a straightforward device construction for optical communication.

Preferably, also, the saturable absorber has the function of a waveform shaper in respect of the signal light. Since, in the intensity distribution of the signal light of the saturable absorber, portions of weak light intensity can be cut off and portions of strong light .intensity can be transmitted, the pulse waveform of the signal light that is transmitted through the saturable absorber can be shaped to a steep waveform.

Preferably, also, the wavelength zone of the saturable absorber that is capable of saturable absorption is at least 1200 nm but no more than 2000 nm.

In this way, matching can be achieved with the wavelength band of the signal light, whose transmission medium is for example a quartz optical fiber as currently employed.

Preferably, also, the signal light is signal light that is emitted from an optical fiber amplifier.

Preferably, also, the optical fiber amplifier is an erbium-doped optical fiber amplifier.

In this way, practical utility can be achieved by enabling matching of the very low loss wavelength band of a quartz optical fiber in an erbium-doped optical fiber amplifier and the saturable absorption wavelength zone of a saturable absorber.

Preferably, also, the signal light is signal light emitted from a semiconductor optical amplifier.

Preferably, also, the signal light is signal light emitted from a semiconductor laser.

Preferably, also, if a plurality of optical fiber amplifier stages are provided consecutively in the transmission path, the saturable absorber may be provided as a repeater between each adjacent optical fiber amplifier.

Since, in this way, a saturable absorption function in respect of the amplified light emitted from the respective consecutive optical fiber amplifiers can be achieved, this is effective in lengthening the span, because transmission of amplified spontaneous emission can be effectively cut off.

Preferably, also, for the carbon nanotube, either or both of a single-wall carbon nanotube or multi-wall carbon nanotube can be employed.

Preferably, the noise reduction apparatus described above can be constituted by providing a carbon nanotube on the surface of an optical component such as a transparent substrate, transparent prism, transparent lens or other component formed by a suitable transparent optical material. Alternatively, the carbon nanotube may be sandwiched between transparent optical materials or may be embedded in transparent optical material.

### BRIEF DESCRIPTION OF THE DRAWINGS

FIG. 1 is a view given in explanation of the optical absorption characteristic of an SWNT thin film;

FIG. 2 is a view of the absorption band portion appearing in the lowest energy region in FIG. 1 wherein the horizontal axis is converted to light wavelength;

FIG. 3 is a view given in explanation of a measurement device for the SWNT thin film, using the Z-scanning method;

FIG. 4 is a view given in explanation of transmissivity at each laser light intensity, when the SWNT thin film is positioned in the vicinity of 40 mm, in measurement of the SWNT thin film using the Z-scanning method;

FIG. 5 is a view given in explanation of an EDFA provided with a signal light noise reduction apparatus according to the present invention;

FIGS. 6(A) to (C) are views given in explanation of the effect of reducing optical noise produced by an SWNT thin film;

FIG. 7 is a view given in explanation of the waveform shaping effect produced by an SWNT thin film;

FIGS. 8(A) and (B) are views given in explanation of a modified example of the embodiment; and

FIG. 9 is a view given in explanation of the construction of a typical EDFA.

### DESCRIPTION OF THE PREFERRED EMBODIMENTS

An embodiment of the present invention is described below with reference to the drawings. It should be noted that in the views employed in the description for example the dimensions, shapes and arrangement relationships of the various structural constituents are only shown diagrammatically such as to enable comprehension of the present invention. Accordingly, the present invention is not restricted solely to the examples illustrated in the drawings.

<1> Verification of the Saturable Absorption Function of the Carbon Nanotubes

(1-1) Manufacture of Carbon Nanotubes

In this embodiment, single-wall carbon nanotubes (hereinbelow referred to as SWNT) constituted by tubular structures consisting of a single sheet of graphen formed by a six-member ring network structure of carbon atoms (C) are employed. However, it should be noted that, for the carbon nanotubes, it would also be possible to employ multi-wall carbon nanotubes (hereinbelow referred to as MWNT) constituted by tubular structures consisting of multi-layer graphen structures; thus, the present invention is not restricted solely to SWNT.

For the manufacture of SWNT, as is generally known, any suitable method may be employed such as a laser evaporation method or arc discharge method. Hereinbelow, a simple description will be given concerning an example of a method of manufacturing SWNT using the laser evaporation method.

First of all, a composite rod is manufactured containing transition metallic elements, for example, cobalt (Co) and nickel (Ni), respectively in the amount of a few atomic% (example 0.6 atomic % respectively) (metal/carbon).

Next, SWNT is manufactured by heating this composite rod to a temperature of about 1200° C. in an electric furnace and then instantaneously evaporating the carbon and catalyst metal using for example a neodymium (Nd)/YAG pulsed laser (10 Hz) while introducing argon (Ar) gas at 50 sccm under reduced pressure of 500 Torr. The SWNT that is thus obtained may be mixed with by-products as impurities and so is preferably refined by any suitable method such as the water heating method, centrifugal separation method or ultrafiltration method.

(1-2) Manufacture of Carbon Nanotubes thin Film

Next, thin film on which SWNT is deposited (hereinbelow referred to as SWNT thin film) is manufactured. For the manufacture of SWNT thin film, preferably SWNT whose diameter is in the range 0.5 nm to 2.0 nm and whose length is in the range 500 nm to 1000 nm is employed. If the diameter and length of the SWNT are in these ranges, the saturable absorption effect can be satisfactorily manifested.

In the embodiment described below, SWNT of mean diameter about 1.3 nm and mean length about 1000 nm was therefore employed.

In order to manufacture SWNT thin film, the spray method is adopted of producing an SWNT thin film by spray application of a dispersion obtained by dispersing SWNT in a dispersion medium onto a transparent optical material i.e. a transparent coated material such as a glass substrate. A brief description of an example of the manufacture of an SWNT thin film by the spray method is given below. For the glass substrate for example a parallel planar plate is employed.

First of all, a dispersion was manufactured by uniformly dispersing SWNT refined by the method described in (1-1) in a dispersion medium comprising at least one of for example alcohol, dichloromethane and dimethyl formaldehyde. If necessary, for example a surfactant may be added in the preparation of the dispersion. The dispersion concentration of SWNT is suitably about 1 to 2 mg/ml if for example ethanol is employed as the dispersion medium. However, it should be. noted that the dispersion concentration is not restricted to this and could be altered at will in accordance with the object and the design.

The dispersion that was thus prepared is dried by spray application onto a glass substrate. If the glass substrate onto which spray application is performed is at low temperature, the SWNT in the applied dispersion coagulates with the result that good film properties are not obtained, so spray application is performed while heating the glass substrate.

An excellent SWNT thin film can be obtained by means of the processes described above. It should be noted that the method of manufacturing SWNT thin film is not restricted to this and for example an electrophoretic deposition method or polymer dispersion method could be employed.

(1-3) Measurement of the Absorption Spectrum of Carbon Nanotubes

An evaluation of the optical absorption characteristic of the SWNT thin film manufactured by the method described in (1-2) was conducted.

SWNT thin film was manufactured by spray application onto a transparent glass substrate of a dispersion obtained by dispersing 1 to 2[mg] of refined SWNT in for example 5[ml] of methanol as dispersion medium.

The results of measurement of the optical absorption characteristic of the SWNT thin film which was thus obtained are shown in FIG. 1. The measurement was conducted using a spectrophotometer U-4000 (manufactured by Hitachi Seisakusho). The horizontal axis of this Figure shows the energy [eV] of the light directed onto the SWNT thin film and the vertical axis shows the absorbance [−] of this SWNT thin film.

As shown in FIG. 1, it can be seen that the SWNT thin film has a plurality of absorption bands in the infra-red region. Also, it can be inferred that this SWNT thin film has semiconductor properties from the fact that it shows an absorption edge in the vicinity of 0.8[eV].

Next, FIG. 2 shows a characteristic obtained by extracting the absorption band that appears at the lowest energy shown in FIG. 1 (in this case, in the vicinity of 1[eV]) and converting the horizontal axis to the wavelength [nm] of the light.

As shown in FIG. 2, it was confirmed that the absorption band in the vicinity of about 1[eV] in FIG. 1 is present in a wavelength region of 1200 nm to 2000 nm and the absorption peak wavelength is in the vicinity of 1780 nm. It should be noted that, although the absorption peak wavelength of SWNT is in the vicinity of 1780 nm under the conditions of this embodiment, it may be envisioned that minute changes in the absorption peak wavelength may be produced by adjusting the diameter and length of the SWNT.

(1-4) Measurement of the Saturable Absorption Function of Carbon Nanotubes

An evaluation of the saturable absorption function of the SWNT thin film was conducted by using the Z-scanning method to measure the relationship between intensity of the incident light and intensity of transmitted light transmitted through the SWNT thin film, by directing illuminating light (laser light) onto the SWNT thin film manufactured by the method already described in (1-2).

The measurement device used in the Z-scanning method is shown diagrammatically in FIG. 3. As shown in FIG. 3, in the measurement device 10 there are arranged in sequence along the optic axis (Z direction) of the incident light from the light source 12: a light source 12 such as a semiconductor laser, a UV cut-off filter 14, an ND filter 16, a lens 18 of focal point distance f of 150 mm and a photodetector 20; the SWNT thin film 15 is arranged between the lens 18 and the photodetector 20.

The change in transmittance with intensity of the incident light directed onto the SWNT thin film 15 was then measured by moving the SWNT thin film 15 along the leftwards direction (direction of the light source 12) in the plane of the drawing of the optic axis (Z axis), taking a position in which the SWNT thin film 15 is offset by about 40 mm towards the photodetector 20 from the focal point F of the lens 18 as the origin X (0: zero).

Laser light of about 1780 nm, which is the absorption peak wavelength of the SWNT, was then output using as the light source 12 a regenerating amplifier titanium sapphire laser provided with an optical parametric amplifier (OPA). Also, measurement was conducted with a pulse width of the laser light of 200 fs, a repetition period of 1 kHz, and six different laser light intensities from the light source 12, namely, 10 μW, 20 μW, 30 μW, 50 μW, 100 μW and 300 μW. It should be noted that the amount of light that is incident on the SWNT thin film 15 is greatest when this SWNT thin film 15 is positioned at the focal point F and decreases as the SWNT thin film 15 moves away from the focal point F. Also, as an example, when the laser light intensity from the light source 12 is 10 μW, the laser beam diameter at the focal point F was about 0.05 mm and the laser light intensity at the focal point F was about 637 MW.

FIG. 4 shows the relationship between the various laser light intensities from the light source 12 and the transmittance when the SWNT thin film 15 was positioned at a position displaced to the vicinity of 40 mm (−40 mm) in the leftwards direction in the drawing from the origin X (0) i.e. when the SWNT thin film 15 was positioned in the vicinity of the focal point F. In FIG. 4, the laser light intensity (laser power) [μW] is shown logarithmically on the horizontal axis and the transmittance [−] is plotted on the vertical axis. The laser power was about 3×10⁻² (3%) at 10 μW, about 9.5×10⁻² (9.5%) at 20 μW, about 16.5×10⁻² (16.5%) at 30 μW, about 32×10⁻² (32%) at 50 μW, about 55×10⁻² (55%) at 100 μW and about 80×10⁻² (80%) at 300 μW.

As can also be understood from FIG. 4, the transmittance differs at each laser light intensity, depending on the intensity of the incident light, but, in the vicinity of −40 mm, which is in the vicinity of the focal point F of the lens 18, optical non-linearity is displayed, in which the transmittance increases. It was thereby confirmed that the SWNT thin film has a saturable absorption function in respect of light (or signal light) of an absorption band in the infra-red region.

However, since, in this embodiment, for example a suitable coating was not applied to the SWNT thin film surface, diffusion of the laser light incident on this SWNT thin film was unavoidable. Accordingly, in this embodiment, taking into account that the laser light loss produced by this diffusion is of the order of about 20%, it is considered that substantially 100% of the incident light (laser light) is transmitted at a transmittance of the order of about 80×10⁻² (80%).

<2> Example of a Construction Utilizing the Saturable Absorption Function of Carbon Nanotubes

First of all, an example construction will be described utilizing a noise reducing apparatus in which the noise of signal light is reduced by providing carbon nanotubes constituting a saturable absorber in the transmission path of the signal light in optical communication.

Furthermore, by combining the saturable absorber that is used as a noise reducing apparatus with an optical amplifier, this can be employed as an optical isolator in respect of light propagated in the opposite direction to the signal light. It can also be utilized as a waveform shaper with respect to the signal light.

FIG. 5 is a constructional diagram given in explanation of an EDFA, which is an optical fiber amplifier comprising a noise reduction apparatus for signal light according to the present invention. Also, FIG. 9 is a constructional diagram of a typical prior art EDFA, given in order to explain the differences in respect of the construction of FIG. 5. It should be noted that although FIG. 5 and FIG. 9 are bidirectional excitation type EDFAs, there is no restriction to this, and the present invention could be suitably applied also to a forward direction excitation type EDFA or backward direction excitation type EDFA.

Also, although, in this embodiment, the description was given taking an EDFA as an example of an optical fiber amplifier, there is no restriction to this and the present invention could suitably be implemented for example using a Raman amplifier.

First of all, an example of a typical EDFA construction will be described with reference to FIG. 9.

As shown in FIG. 9, a typical bidirectional excitation type EDFA 30 is provided between an input 32 and output 42 and comprises optical combiners/splitters 34, 34′, exciting light sources 36, 36′, optical isolators 38, 38′ and an erbium-doped optical fiber (hereinbelow called EDF) 40. The optical isolators 38, 38′ function as non-reciprocal circuits that suppress reflected light (optical noise) that is propagated in the opposite direction to the signal light and that is chiefly generated at the terminals of the input 32 and output 42 constituting the connection terminals of the EDFA 30 with other fibers.

An outline of the operation of the bidirectional excitation type EDFA 30 is as follows.

First of all, the signal light that is incident from the input 32 is combined with the exciting light that is emitted from the exciting light source 36 in the optical combiner/splitter 34, passes through the optical isolator 38 and is then amplified by the EDF 40. Unwanted light such as residual excitation light in the optical combiner/splitter 34′ and optical isolator 38′ is split from the amplified light and the amplified light is emitted at the output 42 as the desired amplified signal light.

FIG. 5 shows a constructional example of the application of noise reducing apparatus for signal light according to the present invention to such a prior art bidirectional excitation type EDFA. An example of embodiment of the present invention is described with reference to FIG. 5.

As shown in FIG. 5, a noise reduction apparatus according to this embodiment is constituted by a saturable absorber using carbon nanotubes. The saturable absorber 15 used in this case is an SWNT thin film formed by application onto a transparent glass substrate as already described in section (1-3).

In this embodiment, the SWNT thin film on the glass substrate may be formed in a film thickness such as to give a transmittance of about 80% or more in respect of the desired signal light. In this way, undesired transmission of optical noise can be effectively reduced without impeding transmission of the desired signal light. In the following description, the noise reduction apparatus may be simply referred to as a saturable absorber.

In this embodiment, this noise reduction apparatus is provided inserted in the transmission path of the signal light of the bidirectional excitation type EDFA 50. In this constructional example, a construction is adopted in which the optical isolator 38′ in the latter stage of the EDF 40 of FIG. 9 is substituted by saturable absorber 15 of carbon nanotubes.

As is well known, the EDFA optically amplifies the signal light of the 1500 nm band in the very low loss wavelength zone of a silica fiber by producing a population inversion in the erbium (Er) by means of exciting light (exciting wavelength: 980 nm or 1480 nm) supplied by a semiconductor laser. Matching of the wavelength zone (roughly 1200 nm to 2000 nm) in which saturable absorption by the SWNT thin film occurs with the wavelength band of the signal light of the EDFA (1500 nm) can therefore be achieved.

In this embodiment, as already described in (1-4), the saturable absorber 15 that replaces the optical isolator 38′ has the characteristic of cutting off light of low light intensity (optical noise) but of transmitting light of strong light intensity (signal light).

Consequently, it was found that, by skillfully utilizing the difference in optical power of this optical noise and optical power of the signal light and passing these to a saturable absorber 15 constituted of carbon nanotubes, the transmittance of the optical noise can be lowered (in fact the optical noise can be substantially cut off) but substantially 100% of the signal light can be transmitted.

Thus, if for example the initial light intensity (optical power) of the optical noise generated in the bidirectional excitation type EDFA 50 is about 10 μW and, compared with this, the initial light intensity (optical power) of the signal light is of a higher level such as for example 50 μW or 100 μW or more, the desired function is achieved by constructing an optical communication system making use of this difference of transmittance in accordance with the signal light intensity. It should be noted that this is merely an example and could be suitably altered at will in accordance with the desired set-up.

Next, a detailed description will be given concerning the changes in signal light waveform and optical noise waveform produced by an EDFA equipped with the signal light noise reduction apparatus, with reference to FIG. 6(A) to (C). It should be noted that FIG. 6(A) to (C) are views to explain diagrammatically the changes in signal light waveform and optical noise waveform and do not necessarily indicate the actual changes of waveform. Also, the horizontal axis in this Figure represents the time t (arbitrary units) and the vertical axis represents the signal intensity (optical power) (arbitrary units).

The signal light a is input from the input 32 shown in FIG. 5 to the bidirectional excitation type EDFA 50 together with the optical noise b generated accompanying propagation of this signal light a. The light intensity of this optical noise b is then fairly small in comparison with the light intensity of the signal light a (see FIG. 6(A)).

In the stages preceding the saturable absorber 15 of the bidirectional excitation type EDFA 50 shown in FIG. 5, the signal light a is amplified to produce signal light a′. Also, in the optical amplification stage of the signal light a, the initial optical noise b and randomly generated spontaneous emission or the like are amplified to produce optical noise b′. The light intensity of this optical noise b′ then becomes of a non-negligible magnitude in comparison with the light intensity of the signal light a′ (see FIG. 6(B)).

By outputting the signal light a′ and the optical noise b′ through the saturable absorber 15, whereas substantially 100% of the signal light a′, which is of large light intensity, is transmitted, producing signal light a″, transmission of the optical noise b′ may be said to be reduced or substantially cut off (see FIG. 6(C)). It should be noted that the waveform shape of the signal light a″ undergoes waveform shaping compared with the waveform shape of the signal light a′ (this is described in detail later).

Also, in this embodiment, shifting the absorption peak wavelength of the SWNTs from the vicinity of 1780 nm to the vicinity of 1500 nm is also desirable in order to produce an outstanding saturable absorption function of the SWNTs. This can be achieved by adjusting the diameter and length of the SWNTs (reduction of the diameter of the SWNTs is particularly effective). However, even if the absorption peak wavelength of the SWNTs and the signal light wavelength are not necessarily made the same, so long as the signal light wavelength is within the SWNT absorption wavelength zone, the SWNTs can be practically used.

Also, although, in this embodiment, a construction was adopted in which the optical isolator 38′ in FIG. 9 was replaced by the saturable absorber 15, a construction in which the optical isolator 38 is replaced by the saturable absorber 15 or a construction in which the saturable absorber 15 is arranged in the latter stage of the bidirectional excitation type EDFA 30 can be expected to give the same effects.

Furthermore, the saturable absorber 15 can likewise perform saturable absorption not merely of the signal light but also of the reflected light of this signal light, which is propagated in the opposite direction to the signal light. Consequently, the saturable absorber 15 shown in FIG. 5 can be utilized as an optical isolator that cuts off transmission of reflected light or can be utilized as an element providing noise reduction of the signal light and an optical isolator of the reflected light. Consequently, the noise reduction apparatus of the present invention can achieve excellent optical transmission with little noise degradation, by insertion in the propagation path of the signal light.

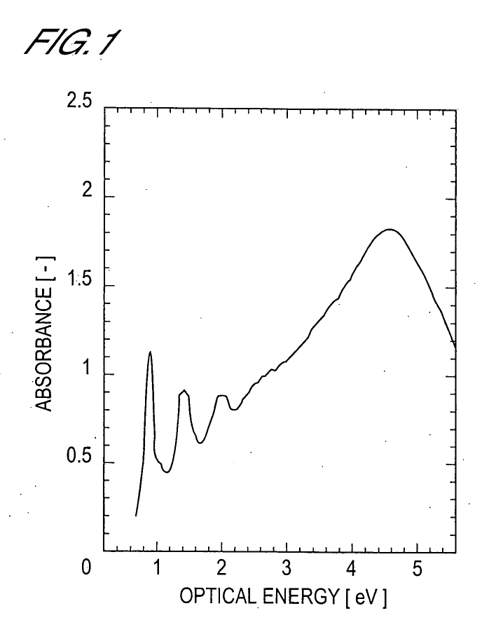

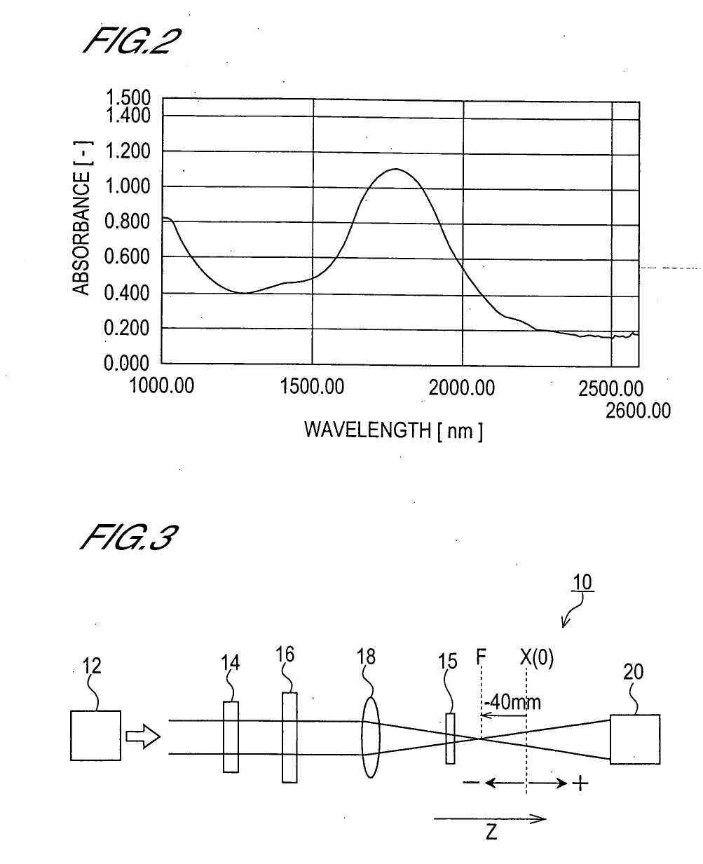

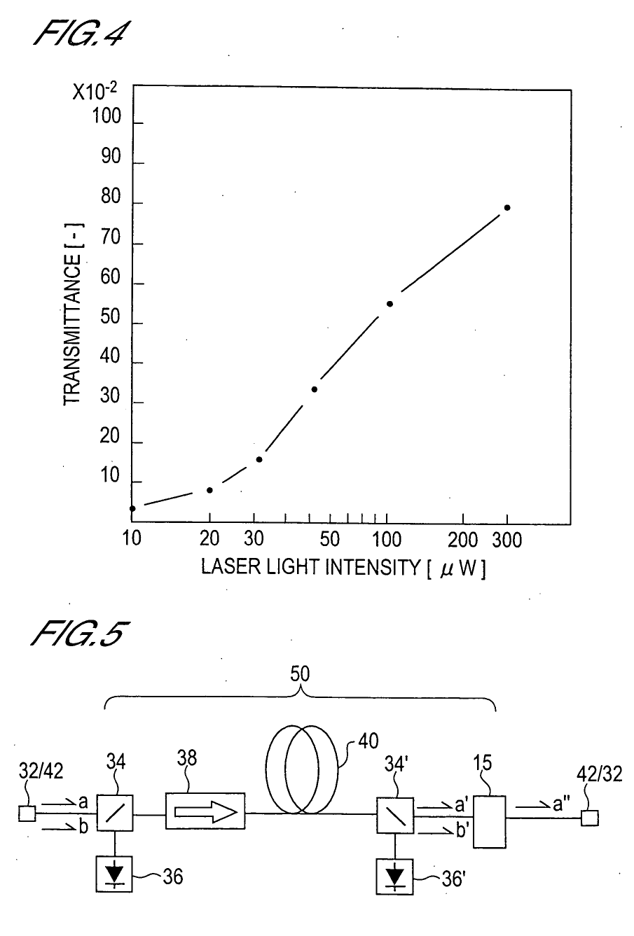

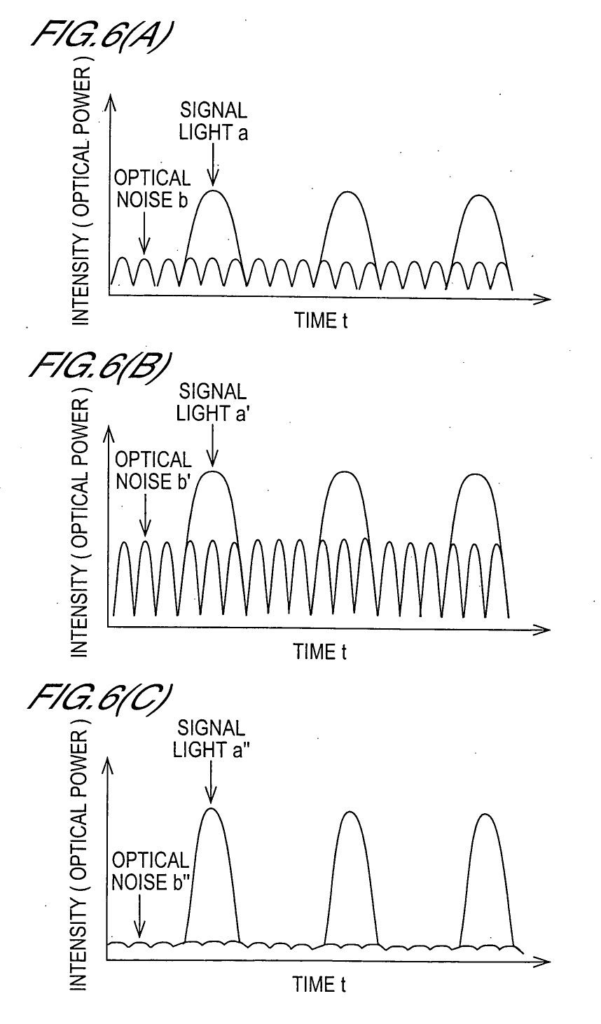

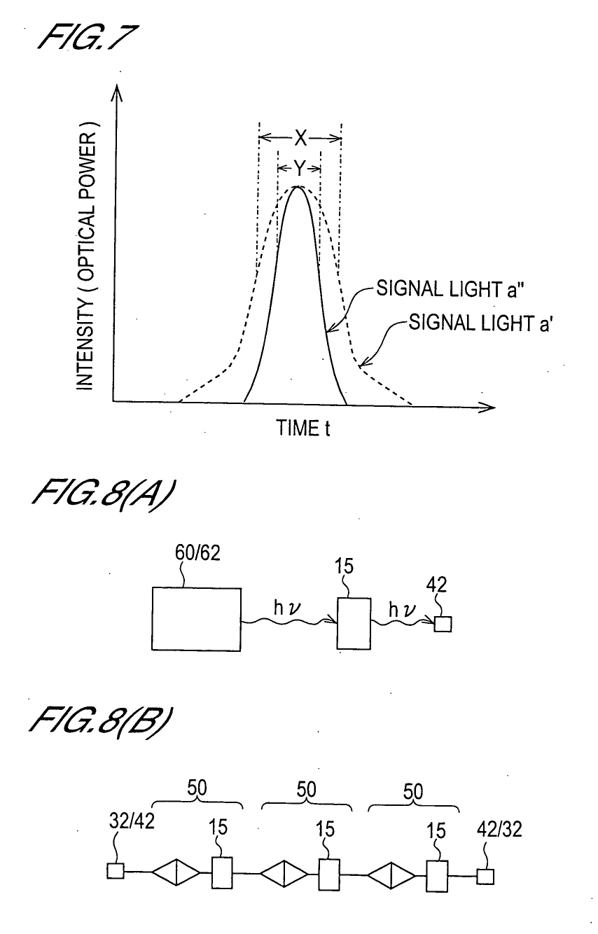

In addition, a case where the saturable absorber 15 is employed as a waveform shaper will be described with reference to FIG. 7. In this Figure, the horizontal axis represents the time t (arbitrary units) and the vertical axis represents the signal light intensity (optical power) (arbitrary units).

As already described, the portion of large light intensity near the center of the light intensity distribution is of high optical transmittance while the optical transmittance of the portions of small light intensity skirting this portion is lower. Consequently, as shown in FIG. 7, the signal light a′ prior to incidence on the saturable absorber 15 (corresponding to the signal light a′ in FIG. 6) becomes the signal light a″, in which the passage of signal light of low light intensity in this signal light a′ has been cut off by passage through the saturable absorber 15.

As a result, the pulsed signal light a″ that is output through the saturable absorber 15 assumes a waveform in which the leading and trailing ends of the signal light a′ have been cut off. The pulse width Y of the signal light a″ therefore becomes narrower than the pulse width x of the signal light a′. Consequently, when the saturable absorber 15 shown in FIG. 5 is employed in respect of pulsed signal light, it can be utilized as a waveform shaper that shapes the pulse time width to a short pulse time width and that shapes the signal light to a steep waveform, for example to a rectangular shape.

Also, since the noise reduction device of the present invention utilizing carbon nanotubes constituting a saturable absorber 15 is an optical device of long life having resistance to optical damage and mechanical damage and resistance to water it may be expected to find a wide range of utilization in the field of optical communication.

The conditions etc of this embodiment of the present invention are not restricted to the combinations described above. The present invention can therefore be applied by appropriately combining conditions in any suitable desired stages.

For example, the saturable absorption function of a noise reduction device according to the present invention can be applied to (signal) light from any suitable generating source without being restricted to signal light from an optical amplifier. For example, although, in the embodiment described above, the case was described in which the noise reduction apparatus employing a saturable absorber was applied to the field of optical communication, it could also be suitably applied to the field of semiconductor devices.

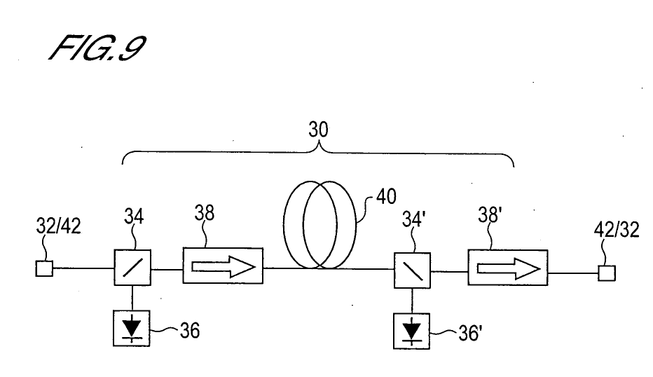

That is, in a construction in which the resonator is omitted from a laser and a semiconductor device, for example a semiconductor constituting an optical amplification medium is employed, as shown in FIG. 8(A), unwanted noise, generated from a semiconductor optical amplifier 60, that tends to cause a lowering of product reliability, can be reduced or excluded by performing saturable absorption in respect of the emitted light by inserting a noise reduction apparatus according to the present invention in the optical path of this light emitted from this semiconductor optical amplifier 60. Also, effects such as reduction or exclusion of noise as described above may be anticipated by inserting a noise reduction apparatus according to the present invention in the optical path of this emitted light also in the case of the semiconductor laser 62.

Also, a construction could be adopted in which, as shown in FIG. 8(B), carbon nanotubes constituting a saturable absorber 15 are provided as repeaters for each adjacent optical fiber amplifier in a case in which a plurality of optical fiber amplifiers, such as for example three consecutive optical fiber amplifiers, (for example bidirectional excitation type EDFAs 50 as shown in FIG. 5) are arranged in the transmission path of the signal light. In this case, saturable absorption is performed in respect of each of the amplified beams emitted from the consecutive optical fiber amplifiers 50, so unwanted ASE can be more efficiently cut-off (reduced).

It should be noted that the number of consecutive optical fiber amplifiers is not restricted to three as described above. For example, in fact, increased transmission distance span while compensating for attenuation of the signal light can be achieved by providing one optical fiber amplifier approximately at each 80 km of the optical fiber. If this is done, amplification of the optical noise is repeated together with the amplification of the signal light, so the effect of optical noise increases to such a degree that it cannot be neglected and, as a result, prevents accurate propagation of the signal light.

Accordingly, as described above, even simply by adopting a construction in which noise reducing apparatus according to the present invention i.e. carbon nanotubes constituting saturable absorbers together with a succession of optical filters are provided so that for example the optical noise level is reduced by about for example 10% for each set of carbon nanotubes, the action is obtained of reducing the effect of optical noise in an extremely effective manner at for example a 10,000 km base point and so of suppressing the drop in S/N ratio.

It should be noted that the glass substrate is not restricted in any way to a parallel planar plate and a glass substrate of any suitable shape could be adopted in accordance with the application or design. Also, instead of the glass substrate, a plastics substrate or the like could be employed as the transparent optical material.

Industrial Applicability

As will be clear from the above description, according to the present invention, the saturable absorption function provided by carbon nanotubes can be utilized in the optical communication field as a noise reducing apparatus for signal light, that transmits signal light of high light intensity but yet cuts off transmission of for example ASE, which is of low signal light intensity. As a result, a reduction in for example ASE can be achieved, so even greater increases in the span of the transmission distance can be achieved.

1. A noise reduction apparatus for signal light is arranged in the transmission path of this signal light in order to reduce noise of the signal light in optical communication and a carbon nanotube is used as a saturable absorber.

2. The noise reduction apparatus for signal light according to claim 1, wherein said carbon nanotube has optical non-linearity.

3. The noise reduction apparatus for signal light according to claim 1, wherein said saturable absorber has a function as an optical isolator in respect of light propagated in the opposite direction to said signal light by combination with an optical amplifier.

4. The noise reduction apparatus for signal light according to claim 1, wherein said saturable absorber has the function of a waveform shaper in respect of said signal light.

5. The noise reduction apparatus for signal light according to claim 1, wherein the wavelength zone of said saturable absorber that is capable of saturable absorption is at least 1200 nm but no more than 2000 nm.

6. The noise reduction apparatus for signal light according to claim 1, wherein said signal light is signal light that is emitted from an optical fiber amplifier.

7. The noise reduction apparatus for signal light according to claim 6, wherein said optical fiber amplifier is an erbium-doped optical fiber amplifier.

8. The noise reduction apparatus for signal light according to claim 1, wherein said signal light is signal light emitted from a semiconductor optical amplifier.

9. The noise reduction apparatus for signal light according to claim 1, wherein said signal light is signal light emitted from a semiconductor laser.

10. The noise reduction apparatus for signal light according to claim 1, wherein said saturable absorber is provided as a repeater between each adjacent said optical fiber amplifier when a plurality of said optical fiber amplifier stages are provided consecutively in said transmission path.

11. The noise reduction apparatus for signal light according to claim 1, wherein said carbon nanotube is either or both of a single-wall carbon nanotube or multi-wall carbon nanotube.

12. The noise reduction apparatus for signal light according to claim 1, wherein said saturable absorber is provided on a transparent optical component.

13. A method of noise reduction of signal light, wherein a carbon nanotube is arranged as a saturable absorber in the transmission path of signal light in optical communication, noise of the signal light being reduced by means of the saturable absorber.
